(19) United States
(12) Patent Application Publication
(10) Pub. No.: US 2006/0096968 A1
(43) Pub. Date: May 11, 2006

(54) Roof Deicing Apparatus

(75) Inventor: John Rice Livermore, Telluride, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: John Rice Livermore, Telluride, CO (US)

(21) Appl. No.: 10/904,366

(22) Filed: Nov. 5, 2004

(51) Int. Cl. H05B 3/00; H05B 1/00; H05B 11/00

(52) U.S. Cl. 219/213

(57) ABSTRACT

A roof deicing apparatus for use on a roof having an upper surface includes a high thermal mass element attached to the upper surface of the roof with a heat source operatively associated therewith.

### TECHNICAL FIELD

The present invention is directed toward a roof deicing apparatus, and more particularly to a roof deicing apparatus using a high thermal mass element.

### BACKGROUND ART

A common problem in areas of heavy snowfall is the formation of ice dams along the edge or eave of a roof. The ice dam forms as a result of water which accumulates on the roof, generally as the result of melting snow, which travels along the roof and then freezes at the edge of the roof.

Numerous prior art devices have been designed for preventing the formation of or melting ice dams. Representative is an ice dam melting system described in Tourangeau, U.S. Pat. No. 5,391,858, the disclosure of which is hereby incorporated by reference in its entirety. The Tourangeau ice dam melting system consists of a heat cell made up of spaced apart conduits which are attached to an upper panel formed of sheet metal. The conduits support the upper panel in a spaced relationship relative to an underlying roof deck (or a lower panel associated with the cell) and define a chamber 64 between the upper and lower panels and the conduits. Heating elements, such as an electric heat generating cable (commonly known as heat tape) are disposed in conduits. Air within the chamber is heated by conduction by the heat tape and the upper panel is heated by conduction from the heat tape and conduction from the heated air in the chamber to melt snow and ice in contact therewith.

Among the problems with the Tourangeau system is the need to form and attach the conduits to the upper surface. Another problem with the Tourangeau system is the difficulty in feeding heat tape through the conduits. Yet another problem with the Tourangeau system is the air trapped within the chamber and the upper panel cool quickly once power to the heat tape is shut off, meaning the Tourangeau system must be powered substantially constantly during periods of potential ice dam formation in order to function effectively.

Numerous other ice dam melting systems known in the art share one or more of these problems with Tourangeau or have short comings. These include systems disclosed in the following patents: Glass, U.S. Pat. No. 3,129,316; Toyooka, U.S. Pat. No. 3,521,029; Norman, U.S. Pat. No. 3,691,343; Gray, U.S. Pat. No. 3,784,783; Stanford, U.S. Pat. No. 4,081,657; Taouil, U.S. Pat. No. 4,769,526; Ohashi, U.S. Pat. No. 4,880,051 and JP 4-31575, the disclosures of each of which are hereby incorporated by reference in their entirety.

The present invention is directed to overcoming one or more of the problems discussed above.

### SUMMARY OF THE INVENTION

The first aspect of the present invention is a roof deicing apparatus including a high thermal mass element and a heat source operatively associated with the high thermal mass element. The high thermal mass element may be made of masonry or concrete. In one embodiment, at least two high thermal mass elements are disposed with a gap therebetween and the heat source is disposed within the gap. In another embodiment, a cover, which may be made of a thermally conductive material such as sheet metal, overlies the high thermal mass element and the heat source. The apparatus may further include a roof deck and a plurality of elongate high thermal mass elements attached to the roof deck substantially in parallel with the gap between the adjacent high thermal mass elements and the heat source disposed within one or more of the gaps. The heat source is preferably an electric heat generating cable, but can be a heat source of any suitable type.

A second aspect of the present invention is a method of making a roof deicing apparatus. The method includes providing a roof deck, attaching a high thermal mass element to the roof deck, operatively associating a heat source with the high thermal mass element and overlying the high thermal mass element and the heat source with a cover. In one embodiment, a plurality of elongate high thermal mass elements are attached substantially in parallel to the roof deck with a gap therebetween and the heat source is operatively associated with one or more gaps. The cover may be thermally conductive, such as sheet metal. The heat source may be an electric heat generating cable but can be a heat source of any suitable type and the electric heat generating cable is operatively associated with a gap by placing a length of it in the gap.

Yet another aspect of the present invention is a roof deicing apparatus for use on a roof having an upper surface. The roof deicing apparatus includes a plurality of elongate high thermal mass elements attached to the upper surface of the roof substantially in parallel with a gap between adjacent elongate high thermal mass elements. A heat source is disposed in each gap. A cover overlies the plurality of elongate high thermal mass elements. The high thermal mass elements may include masonry or concrete. The cover may be thermally conductive and is preferably made of a sheet metal. The heat source is preferably an electric heat generating cable but can be a heat source of any suitable type.

### BRIEF DESCRIPTION OF THE DRAWINGS

FIG. 1 is a side elevation view of a cross-section of one embodiment the roof deicing apparatus of the present invention installed on a roof deck;

FIG. 2 is a top plan view of the roof deicing apparatus of FIG. 1; and

FIG. 3 is a side elevation view of a cross-section of an alternate embodiment of the roof deicing apparatus of the present invention installed on a roof deck.

### DETAILED DESCRIPTION OF THE INVENTION

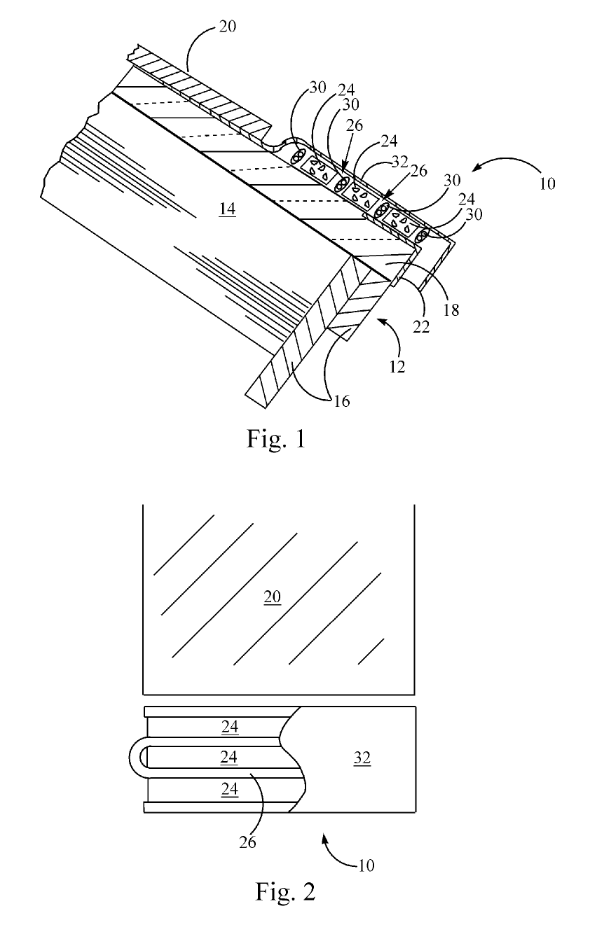

A roof deicing apparatus 10 of the present invention is depicted in FIGS. 1 and 2. Referring first to FIG. 1, the roof deicing apparatus 10 is intended for installation on a roof eave 12. The roof eave 12 includes a soffit 14, fascia 16, a roof deck 18 and a roofing material 20 which may include metal panels, shingles, cedar shakes, tiles, and virtually any other roofing materials known in the art. While the roof deicing apparatus 10 in FIGS. 1 and 2 is shown disposed upon a roof eave, the roof deicing apparatus 10 may also be deployed upon roof edges extending over sidewalls and rafters as illustrated in FIGS. 2-5 of the Tourangeau patent, or any other conventional roof structure.

As illustrated in FIG. 1, an eave or drip edge flashing 22 overlies an edge of the roof deck 18. However, the drip edge flashing 22 may not be included in all installations of the roof deicing apparatus.

The roof deicing apparatus 10 comprises one or more high thermal mass elements which are attached directly to the roof deck or which may have a bottom panel underlying the high thermal mass units. In the embodiment of FIGS. 1 and 2 a plurality of elongate high thermal mass elements 24 are attached to the roof deck 18 substantially parallel to an edge of the eave with a gap 26 between adjacent elongate high thermal mass elements. The elongate high thermal mass elements are made of a high thermal mass material, which is a material having a high heat (or thermal) capacity, such as masonry or concrete. By way of example and not limitation, examples of suitable masonry material include stone, brick and tile. Such materials have the property of both warming and cooling relatively slowly. As depicted in FIG. 1, the elongate high thermal mass elements are attached directly to the roof deck, which may be made of plywood or other suitable conventional construction materials. At least a portion of an elongate high thermal mass element may overlie an eave or drip edge flashing 22. The elongate high thermal mass elements may be attached to the plywood roof deck edge flashing or a bottom panel by adhesives, two sided tapes, nails, screws or other suitable attachment devices.

A heat source is disposed in operative association with the elongate high thermal mass element(s). As used herein, “operative association” or “operatively associating” the heat source with the high thermal mass element(s) means situating the heat source relative to the elongate high thermal mass element(s) to effectively transfer heat from the heat source to the high thermal mass elements by convection, radiation or conduction. In those embodiments where the heat source is an electric heat generating cable, “operative association” means transfer of heat by conduction or radiation. In the embodiment of FIGS. 1 and 2, the operative association is accomplished by disposing a heat source 30 in each gap 26 between adjacent elongate high thermal mass elements 24. In the embodiment of FIGS. 1 and 2, the heat source 30 is an electric heat generating cable, also known as heat tape. Suitable heat tapes include Model SR82J manufactured by Easyheat of East Granby, Conn. The heat source 30 may also include hot water, steam or various chemicals circulated through closed conduits and could also include heated air circulated through the gaps 26. In the embodiment shown in FIGS. 1 and 2, the heat source 30 is also provided adjacent to an exposed lengthwise edge of each high thermal mass element 24 located on an end of the plurality of elongate high thermal mass elements 24.

A cover is configured to overlie the elongate high thermal mass element(s) and associated heat source. In the embodiment of FIGS. 1 and 2, cover 32 is thermally conductive. Acceptable thermally conductive materials include, but are not limited to, a sheet metal such as galvanized steal, stainless steal, copper or other metal is selected for durability, heat transfer coefficient, and/or an aesthetic match with existing building materials. The thermally conductive cover 32 preferably has one lengthwise side configured to underlie the roofing material 20 and various bends to enable it to overlie the elongate high thermal mass elements 24 and the heat source 30 with a distal lengthwise side bent to overlie the edge of the roof deck 18 so as to prevent water from flowing under the cover 32. With a load such a s snow disposed upon the cover 32, the high thermal mass elements 24 may support the cover 32.

In an alternate embodiment which is not illustrated, the cover may be the roof material 20 extending partially or completely over the roof deicing apparatus 10. In such an embodiment, the roof material may extend to the roof edge or beyond, with the roof material then, in effect, transferring the heat to the ice and/or snow thereon. In a further alternate embodiment which is not illustrated, the roof material may extend over part or all of a cover of the embodiment illustrated in FIGS. 1 and 2.

The elongate high thermal mass elements 24 disposed between the heat source 30 act as heat sinks and modulate the temperature of the thermally conducive cover 32 to enable it to effectively melt snow or ice collecting thereon without excessively heating the thermally conductive cover 32. In addition, the elongate high thermal mass elements 24 can warm under the effect of the sun or warm ambient daytime temperatures to provide heat to the thermally conductive cover 32 when the sun is obscured or in the evening as temperatures drop, thereby minimizing the amount of heat energy that must be provided by the heat source.

The roof deicing apparatus 10 of FIGS. 1 and 2 is installed by attaching the elongate high thermal mass elements 24 parallel to a roof edge with a gap therebetween. In one embodiment, the high thermal mass elements 24 are made of concrete and are screwed to the roof deck. After installation of the high thermal mass elements 24, an electric heat generating cable is disposed adjacent the exposed lengthwise sides of the end high thermal mass elements and within the gaps between the high thermal mass elements in a serpentine manner, as illustrated in FIG. 2. The cover is then installed with one lengthwise end under the roofing material and the other end overlying the high thermal mass elements and the electric heat generating cable.

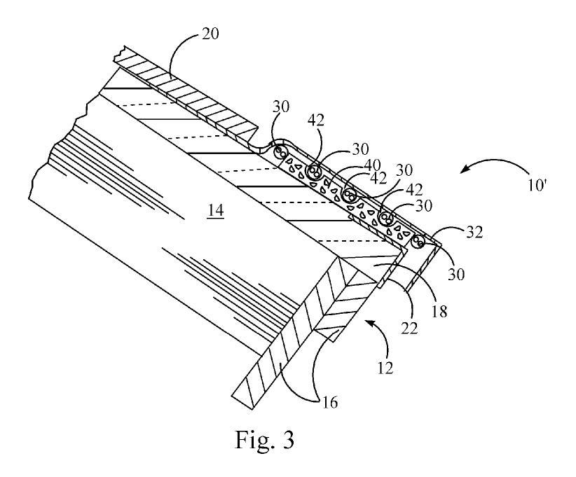

FIG. 3 is an alternate embodiment of the roof deicing apparatus 10′ in accordance with the present invention. Like elements have the same reference numbers as used in FIGS. 1 and 2. The only substantial difference in roof deicing apparatus 110′ is the high thermal mass element 40 is a single elongate piece having a plurality of lengthwise gaps or grooves 42 which receive the heat source 30. The gaps or grooves effectively cause adjacent portions of the high thermal mass element 40 to act as separate elements. The heat source 30 may extend beyond a top surface of the high thermal mass element 40 or may lie entirely within the grooves 42 so as to not directly contact the cover 32.

### EXAMPLE

A roof deicing apparatus 10 as illustrated in FIGS. 1 and 2 was made using high thermal mass elements 24 having dimensions approximately 3 inch×2 inch×4 feet, made of cement board reinforced with fiberglass. The cover 32 was made of 26 gage sheets of steel. The heat source 30 was an electric heat generating cable model no. SR82J, manufactured by Easyheat of East Granby, Conn.

The materials from which the roof deicing apparatus of the present invention is made are readily available and relatively inexpensive. In addition, the materials are easy to work with. As a result, the roof deicing apparatus in accordance with the present invention is relatively inexpensive to acquire and install.

The description of the present invention has been presented for the purposes of illustration and description, but is not intended to be exhaustive or limited to the invention in the form disclosed or as a limitation on the scope of the claims. Many modifications will be apparent to those of ordinary skill in the art. The embodiments herein were chosen and described in order to best explain the principles of the invention, the practical application, and to enable others of ordinary skill in the art to understand the invention for various embodiments with various modifications as are suited to the particular use contemplated.

What is claimed is:

1. A roof deicing apparatus comprising:
a high thermal mass element; and
a heat source operatively associated with the high thermal mass element.

2. The apparatus of claim 1 wherein the high thermal mass element comprises at least one of masonry and concrete.

3. The apparatus of claim 2 wherein the masonry comprises at least one of stone, brick and tile.

4. The apparatus of claim 1 further comprising at least two high thermal mass elements disposed with a gap therebetween and the heat source disposed within at least one such gap.

5. The apparatus of claim 1 further comprising a thermally conductive cover overlying the high thermal mass element and the heat source.

6. The apparatus of claim 1 wherein the thermally conductive cover is made of a sheet metal.

7. The apparatus of claim 1 further comprising:
a roof deck, the high thermal mass element being attached to the roof deck; and
a thermally conductive cover overlying the high thermal mass element and the heat source.

8. The apparatus of claim 7 further comprising a plurality of high thermal mass elements, each high thermal mass element being elongate, the elongate high thermal mass elements being attached to the roof deck substantially in parallel with a gap between adjacent elongate high thermal mass elements, the heat source being disposed within at least part of one gap.

9. The apparatus of claim 8 further comprising the heat source being adjacent an exposed lengthwise edge of each high thermal mass element located on an end.

10. The apparatus of claim 9 wherein the heat source is an electric heat generating cable.

11. The apparatus of claim 10 further comprising a drip edge flashing underlying at least part of one elongate high thermal mass element.

12. A method of making a roof deicing apparatus comprising:
providing a roof deck;
attaching a high thermal mass element to the roof deck;
operatively associating a heat source with the high thermal mass element; and
overlying the high thermal mass element and the heat source with a cover.

13. The method of claim 12 wherein the cover is thermally conductive.

14. The method of claim 12 further comprising:
attaching a plurality of elongate high thermal mass elements to the roof deck in parallel with a gap therebetween; and
operatively associating the heat source with each gap.

15. The method of claim 14 wherein the heat source is an electric heat generating cable and the electric heat generating cable is operatively associated with each gap by placing a length of it in each gap.

16. The method of claim 15 further comprising placing the electric heat generating cable in a serpentine path.

17. The method of claim 14 wherein the elongate high thermal mass elements are attached to the roof deck substantially parallel to an eve edge of the roof deck.

18. The method of claim 12 wherein the high thermal mass element comprises at least one of masonry and concrete.

19. The method of claim 18 wherein the masonry comprises at least one of stone, brick and tile.

20. The method of claim 15 further comprising placing a length of the electric heat generating cable adjacent an exposed lengthwise edge of each high thermal mass element located on an end.

21. The method of claim 12 wherein the cover comprises a roofing material.

22. The method of claim 13 wherein the thermally conductive cover comprises a sheet metal.

23. A roof deicing apparatus for use on a roof having an upper surface, the roof deicing apparatus comprising:
a plurality of elongate high thermal mass elements attached to the upper surface of the roof substantially in parallel with a gap between adjacent elongate high thermal mass elements;
a heat source disposed in at least one part of one gap; and
a cover overlying the plurality of elongate high thermal mass elements.

24. The apparatus of claim 23 wherein the cover is thermally conductive.

25. The apparatus of claim 24 wherein the high thermal mass element comprises at least one of masonry and concrete.

26. The apparatus of claim 25 wherein the masonry comprises at least one of stone, brick and tile.

27. The apparatus of claim 25 wherein the thermally conductive cover is made of a sheet metal.

28. The apparatus of claim 25 further comprising the heat source being adjacent an exposed lengthwise edge of each elongate high thermal mass element located on an end.

29. The apparatus of claim 28 wherein the heat source is an electric heat generating cable.
